(19) United States
(12) Patent Application Publication
(10) Pub. No.: US 2009/0034951 A1
(43) Pub. Date: Feb. 5, 2009

(54) REMOTE PHOTOGRAPHING SYSTEM

(75) Inventor: Shinya Kawasaki, Sagamihara-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/170,500

(22) Filed: Jul. 10, 2008

(30) Foreign Application Priority Data
Jul. 12, 2007 (JP) 2007-183653

(51) Int. Cl. G03B 17/00; H04N 5/225

(52) U.S. Cl. 396/57; 348/207.11; 348/E05.024

(57) ABSTRACT

A remote photographing system of the invention includes a digital camera having: a communication portion for receiving various data from a PC and transmitting a picked-up image to the PC; an image pickup control portion and a control portion for adjusting a focus when acquiring an image; and an image pickup portion for acquiring an image. The PC includes: a communication portion for receiving an image from the digital camera and transmitting positional information thereto; a display portion for displaying the image from the digital camera; an input portion for instructing an arbitrary part of the displayed image; an enlarged display portion for displaying the instructed part in an enlarged manner; and a control portion for acquiring positional information of the instructed part. The image pickup control portion and the control portion adjust to bring the instructed part of the image into focus.

This application claims benefit of Japanese Application No. 2007-183653 filed on Jul. 12, 2007, the contents of which are incorporated by this reference.

### BACKGROUND OF THE INVENTION

1. Field of the Invention

The present invention relates to a remote photographing system capable of accurately bringing a camera into focus when remotely operating the camera using a remote operation device.

2. Description of Related Art

In recent years, digital cameras equipped with a wireless communication function such as wireless LAN have been put into practical use. Thanks to the inclusion of the wireless communication function, such digital cameras are capable of wirelessly transmitting and receiving a picked-up image between the digital camera and other electronic devices such as a personal computer and the like.

In addition, some of these digital cameras are remotely controlled by other electronic devices such as a PC or a remote controller, for example. In the remote photographing system having such a digital camera and above-described other electronic devices, a photographer is capable of easily checking a composition by using a remote control function for remotely controlling the digital camera in a case of taking a group photo, for example, even if the photographer is at a distant position.

Many proposals have been conventionally made for such a remote photographing system in order to improve usability for a user.

For example, Japanese Patent No. 2637713 discloses a technique related to a camera system which allows an image (referred to as a through image) corresponding to the image picked up by a camera to be displayed also on a remote controller side so that a user can check the picked-up image even when the user remotely operates the camera.

In addition, Japanese Patent Application Laid-Open Publication No. 2002-94867 discloses a technique related to a remote image pickup system in which a photographing setting of a camera can be performed on a PC side in remotely operating the camera and also an image picked up with the photographing setting performed on the PC side can be transferred to the PC.

Moreover, Japanese Patent Application Laid-Open Publication No. 2005-210589 discloses a technique related to a remote control system in which a user can continuously release a camera shutter if the user continues to depress a mouse button on a PC side when remotely controlling the camera.

In addition, all of the Japanese Patent No. 2637713, and the Japanese Patent Application Laid-Open Publications Nos. 2002-94867, 2005-210589 disclose a technique in which a user checks the focusing position on a camera side when remotely operating the camera by other devices such as a PC or a remote controller.

Thus, an object of the present invention is to provide a remote photographing system capable of accurately bringing a camera into focus on the side of other devices in remotely operating the camera, without confirming an image after photographing.

### SUMMARY OF THE INVENTION

A remote photographing system according to the present invention comprises a photographing device, and a remote operation device for remotely operating the photographing device by a wireless or a wired communication method, wherein the photographing device includes: a data receiving portion for receiving various data transmitted from the remote operation device; a focal point adjusting portion for adjusting a focus when acquiring an image of a subject; an image acquisition portion for acquiring the image of the subject; and a transmitting portion for transmitting the image to the remote operation device, and the remote operation device includes: an image receiving portion for receiving an image transmitted from the photographing device; an image display portion for displaying the image transmitted from the photographing device; an instruction portion for instructing an arbitrary part of the image displayed on the image display portion; an enlarged display portion for displaying the arbitrary part of the image instructed by the instruction portion in an enlarged manner; a positional information acquisition portion for acquiring positional information of the arbitrary part of the image instructed by the instruction portion; and a transmitting portion for transmitting the positional information to the photographing device, and the focal point adjusting portion adjusts to bring the arbitrary part of the image instructed by the instruction portion into focus.

### BRIEF DESCRIPTION OF THE DRAWINGS

FIG. 1 is a block diagram showing an embodiment of a remote photographing system according to the present invention and illustrating an entire configuration of a remote operation system.

FIG. 2 is a diagram showing a display example of a remote operation mode screen displayed by a PC application during execution of a remote operation mode.

FIG. 3 is an illustration diagram showing a display transition example based on the PC application for each remote operation during the execution of the remote operation mode.

FIG. 4 is a timing chart showing timings of mouse actions of the PC and release command issuance.

FIG. 5 is an illustration diagram showing a relationship between an image pickup area and an enlarged through image area on a screen displayed on the PC.

FIG. 6 is a diagram showing a display example of a display portion of the digital camera when a focusing instruction is made by operation of a mouse of the PC.

FIG. 7 is a flowchart showing control procedures from when the remote photographing mode was executed until through images are displayed on the PC side during execution of the remote photographing mode.

FIG. 8 is a flowchart showing control procedures from a procedure of acquiring setting data required for photographing on the PC side while watching the through images in FIG. 7 to a procedure of saving on the PC side the image photographed in response to a release instruction.

### DETAILED DESCRIPTION OF PREFERRED EMBODIMENTS

Hereinafter, an embodiment of the present invention will be described with reference to the drawings.

### (An Embodiment)

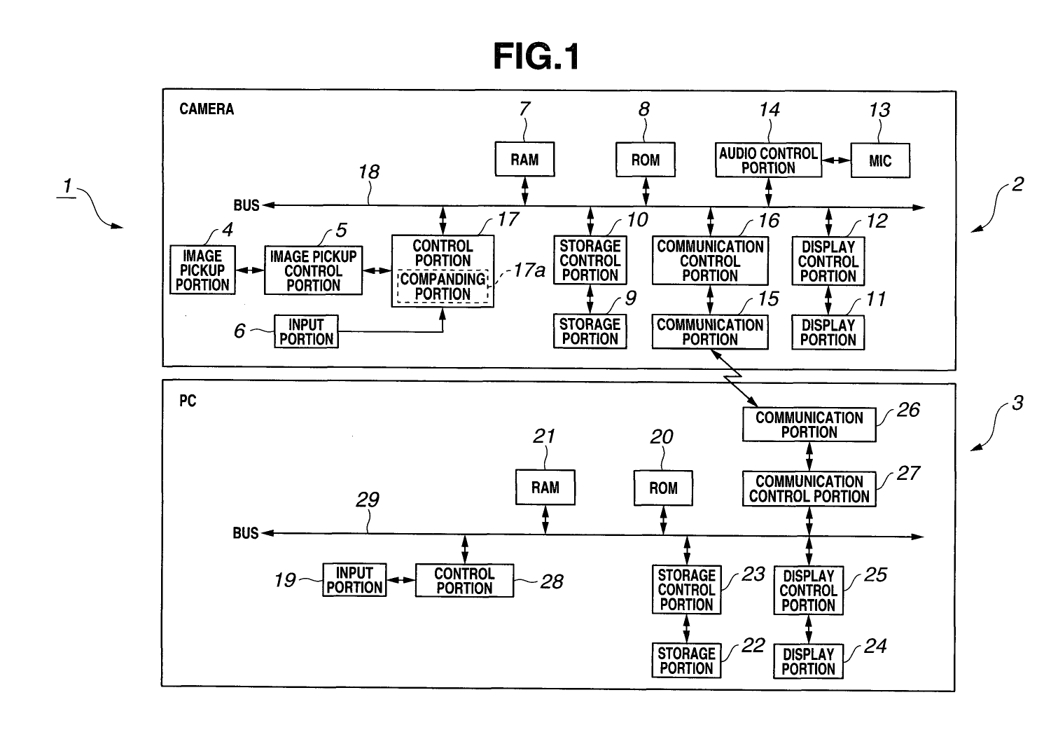

FIG. 1 is a block diagram showing an embodiment of a remote photographing system according to the present invention and illustrating an entire configuration of a remote operation system.

As shown in FIG. 1, a remote photographing system 1 according to the embodiment includes, for example, a digital camera 2 configuring a photographing device and a PC 3 configuring a remote operation device for remotely operating the digital camera 2 by a wireless or wired communication method. Note that, in the present embodiment, description will be made on the case where the PC 3 is used as the remote operation device, for example.

First, a configuration of the digital camera 2 is described.

As shown in FIG. 1, the digital camera 2 includes an image pickup portion 4, an image pickup control portion 5, an input portion 6, a RAM 7, a ROM 8, a storage portion 9, a storage control portion 10, a display portion 11, a display control portion 12, a MIC 13, an audio control portion 14, a communication portion 15, a communication control portion 16, and a control portion 17. These block circuits are electrically connected on a bus 18.

Note that the image pickup portion 4, the image pickup control portion 5, the input portion 6, the RAM 7, the storage portion 9, the storage control portion 10, the control portion 17, and the like configure an image acquisition portion. In addition, the image pickup portion 4 and the image pickup control portion 5 are configured also as a focal point adjusting portion. Furthermore, the communication portion 15, the communication control portion 16, and the control portion 17 configure a data receiving portion and a transmitting portion.

The image pickup portion 4 is configured of a lens not shown, an image pickup device such as a CCD for converting the light condensed by the lens into an electric signal, and a peripheral circuit of the image pickup device. The image pickup control portion 5 controls the image pickup portion 4.

The input portion 6 includes a switch for giving instructions to the digital camera 2. The ROM 8 stores various control programs, and the RAM 7 temporarily retains data for executing the control programs stored in the ROM 8. That is, the RAM 7 is used as a work area as is well known.

The storage portion 9 stores photographed image data. The storage control portion 10 controls the reading and writing of the image data out of and into the storage portion 9.

The display portion 11 displays photographed images and various pieces of information, and is configured of an LCD (liquid crystal display) and the like, for example. The display control portion 12 controls display items, display size, and the like, of the display portion 11.

The MIC 13 has functions to collect audio and import the collected audio as an audio signal and to output the audio signal as audio. The audio control portion 14 controls input/output of the audio signal to the MIC 13.

The communication portion 15 is means to transmit and receive data to and from an external device, for example, the PC 3, using a wired or wireless communication method. The communication control portion 16 controls the communication by the communication portion 15, that is, controls data transmission/reception via the communication.

Furthermore, the control portion 17 controls the entirety of the digital camera 2, for example, the control portions 5, 10, 12, 14, 16, the ROM 8, and the RAM 7.

Next, description will be made on a specific configuration of the PC 3.

As shown in FIG. 1, the PC 3 includes an input portion 19, a ROM 20, a RAM 21, a storage portion 22, a storage control portion 23, a display portion 24, a display control portion 25, a communication portion 26, a communication control portion 27, and a control portion 28. These block circuits are electrically connected on the bus 29.

Note that the communication portion 26, the communication control portion 27, and the control portion 28 configure an image receiving portion and the transmitting portion. In addition, the display portion 24, the display control portion 25, and the control portion 17 configure the image display portion, and the input portion 19 and the control portion 28 configure an instruction portion, an enlarged display portion, and a positional information acquisition portion.

The input portion 19 is an input portion configured of a mouse, a keyboard, and the like, for example. The ROM 20 stores various control programs and the RAM 21 temporarily retains data for executing the control programs stored in the ROM 20. That is, the RAM 21 is used as a work area as is well known.

The storage portion 22 stores various data such as photographed image data and the like. The storage control portion 23 controls the reading and writing of the image data out of and into the storage portion 22.

The display portion 24 displays photographed images and various pieces of information such as text and the like, and is configured of an LCD, a monitor, and the like, for example. The display control portion 25 controls the display items to be displayed on the display portion 24 and a size of an image to be displayed on the display portion 24.

The communication portion 26 is means to transmit and receive data to and from the external device, for example, the digital camera 2 using a wired or wireless communication method. The communication control portion 27 controls the communication by the communication portion 26, that is, controls data transmission/reception via the communication.

In addition, the control portion 28 controls the entirety of the PC 3, and is configured of a CPU and the like for controlling the control portions 23, 25, 27, the ROM 20, and the RAM 21, for example.

Next, a basic action of the remote photographing system 1 thus configured will be described.

The remote photographing system 1 shown in FIG. 1 controls the photographing action of the digital camera 2 located at a distant position by operating the mouse as the input portion 19 of the PC 3, for example.

In this case, a user first wirelessly connect the PC 3 and the digital camera 2 each other through the respective communication portions 26 and 15. Note that, in order to safely perform the wireless connection through the communication portions 26 and 15, a communication subjected to a security processing such as encryption may be performed.

Upon completion of the wireless connection through the communication portions 26 and 15, the control portion 28 of the PC 3 reads out the application for performing a remote photographing from the ROM 20 to activate the application on the RAM 21.

Note that, in the present embodiment, the application is an application software (program) for displaying, for example, the setting items, a through image display area, and a zoom lever and the like and performing remote operation using the display.

After the photographing with the digital camera 2, the image data picked up by the image pickup portion 4 of the digital camera 2 is processed by a companding portion 17a provided in the control portion 17 of the digital camera 2, and thereby generated as a through image.

The generated through image is displayed on the display portion 11 (for example, LCD) of the digital camera 2 through the RAM 7 and the display control portion 12.

When the remote operation mode is executed in the digital camera 2, the image data of the through image is transmitted to the communication portion 26 of the PC 3 through the communication portion 15 by the control of the communication control portion 16.

Note that it is not preferable, from the viewpoint of power consumption, to display the through image on the display portion 11 (LCD) of the digital camera 2 during the execution of the remote operation mode in the digital camera 2. Therefore, it may be configured such that the control portion 28 of the PC 3 controls ON/OFF of the display by the display portion 11 in the present embodiment.

Then, the communication portion 26 of the PC 3 receives the image data of the through image that has been transmitted by the communication portion 15 of the digital camera 2, thereafter the transmitted image data is temporarily stored in the RAM 21 by the control of the communication control portion 27. The image data of the through image stored in the RAM 21 is read out by the control of the display control portion 24 of the control portion 28, and thereafter the read-out image data is displayed at a position suitable for the through image display area based on the PC application.

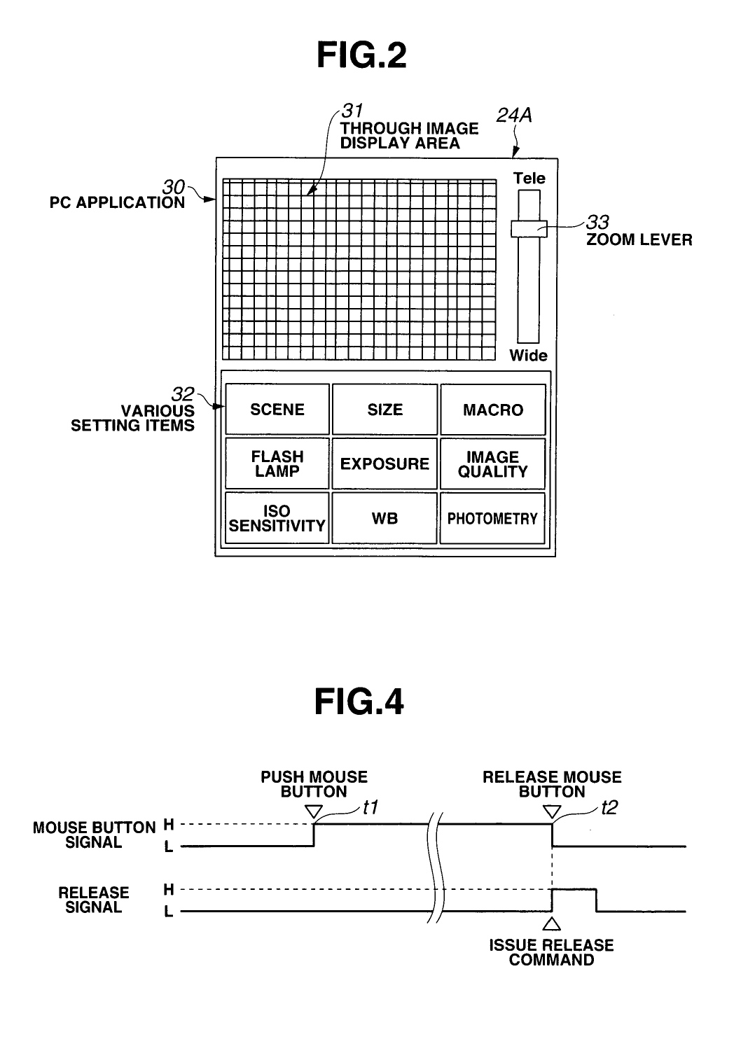

Next, with reference to FIGS. 2 to 8, description will be made on a specific configuration and method (control procedures) for remotely operating the digital camera 2 by the PC 3 in the remote photographing system 1.

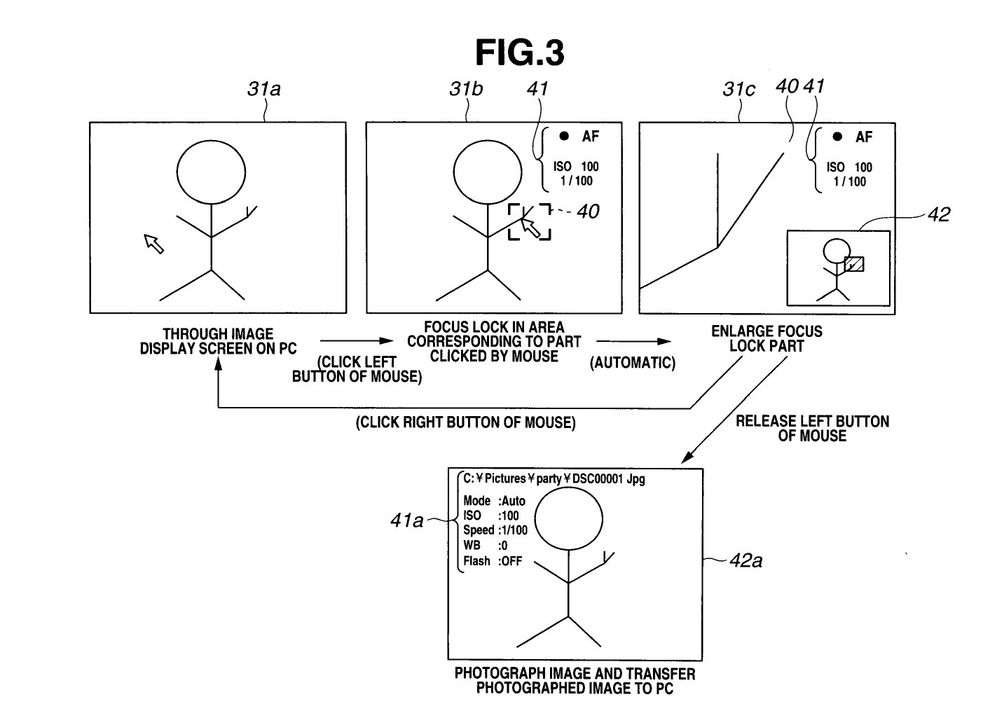

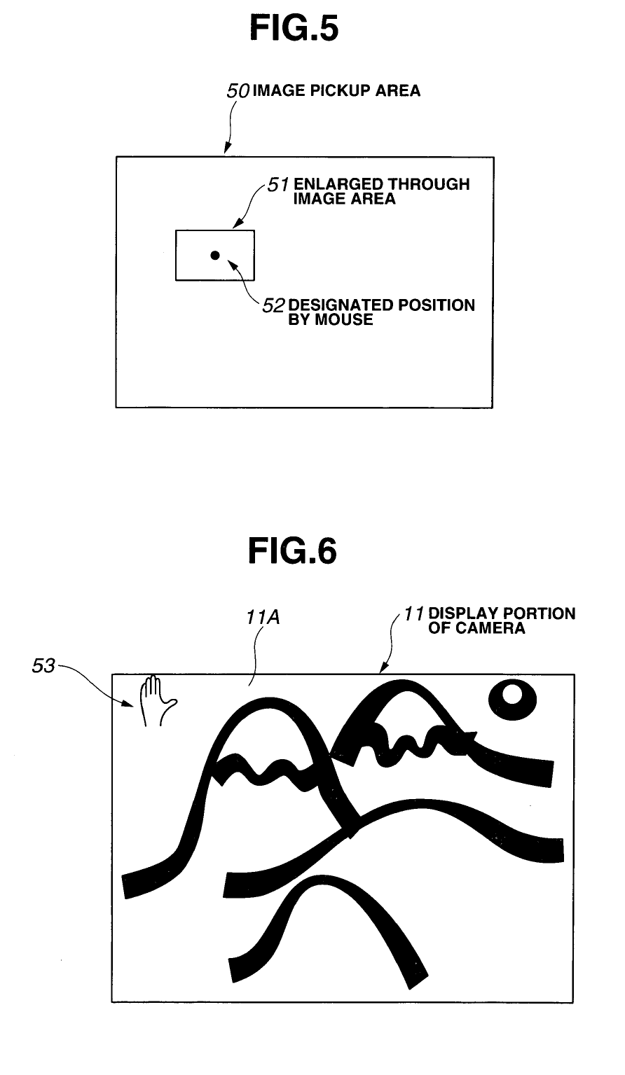

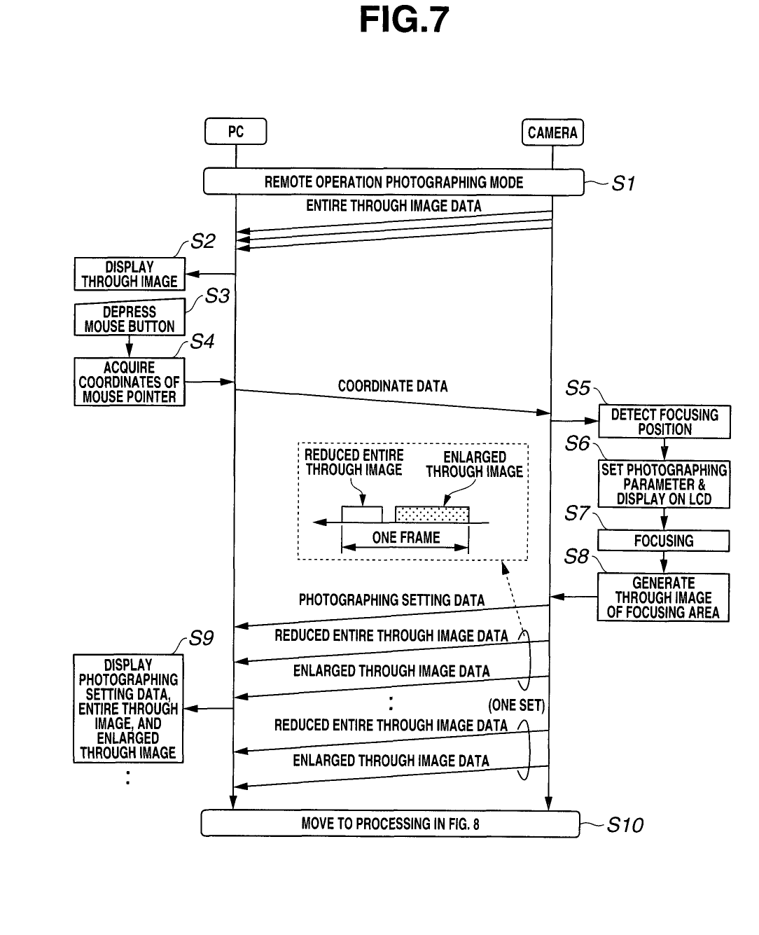

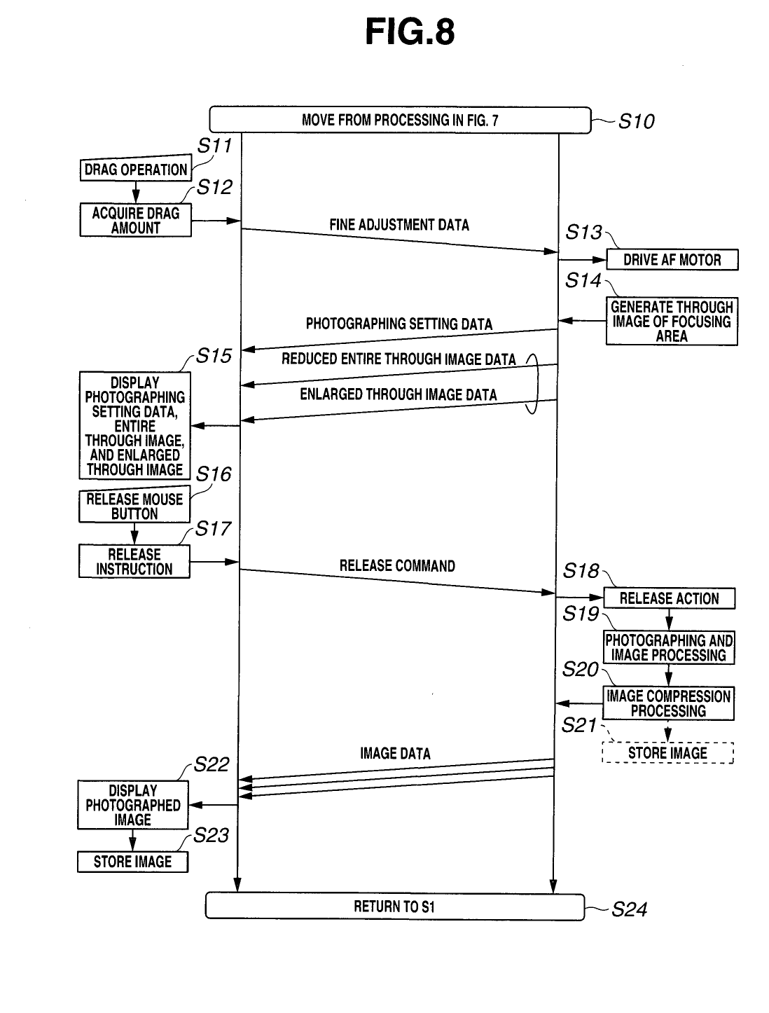

FIG. 2 is a diagram showing a display example of a remote operation mode screen displayed by a PC application during execution of the remote operation mode. FIG. 3 is an illustration diagram showing a display transition example based on the PC application for each remote operation during the execution of the remote operation mode. FIG. 4 is a timing chart showing timings of mouse actions of the PC and a release command issuance. FIG. 5 is an illustration diagram showing a relationship between an image pickup area and an enlarged through image area on a screen displayed on the PC. FIG. 6 is a diagram showing a display example of a display portion 11 of a digital camera when a focusing instruction is made by operation of the mouse of the PC. FIGS. 7 and 8 illustrate flowcharts showing the control procedures during the execution of the remote photographing mode as a feature of the remote photographing system 1. FIG. 7 shows procedures from when the remote photographing mode was executed until the through images are displayed on the PC side, and FIG. 8 shows the procedures from the procedure of acquiring setting data required for photographing on the PC side while watching the through images to the procedure of saving the image photographed in response to a release instruction on the PC side.

When the digital camera 2 is remotely operated by the PC 3 in the remote photographing system 1 shown in FIG. 1, a processing for executing the remote photographing mode is performed between the digital camera 2 and the PC 3 in the processing in step S1, as shown in FIG. 7.

That is, the digital camera 2 is connected to the PC 3 or an access point connected to the PC 3 through the communication portion 15. In other words, the PC 3 and the digital camera 2 can be connected to each other through a network, for example.

Note that the access point and the PC 3 are connected by a wire such as Ethernet (registered trademark) cable and the like. In addition, the access point is a public access point, and the access point may be connected to the PC 3 via the Internet.

The digital camera 2 transmits a connection request to the PC 3 based on wireless connection information stored in the digital camera 2. Then, in response to the connection request, the PC 3 starts connection processing, and thus completes the wireless connection between the digital camera 2 and the PC 3. That is, the wireless connection is completed by the communication performed between the communication portions 15 and 26 by the control of the respective communication control portions 16, 27 of the control portions 17, 28 of the digital camera 2 and the PC 3.

After that, the control portion 28 of the PC 3 reads out a predetermined application stored in the ROM 20 to activate the application using the work area of the RAM 21.

When a user issues an instruction using the input portion 19 to switch the mode of the digital camera 2 to the remote operation photographing mode by the activated application, the control portion 28 of the PC 3 transmits a remote operation photographing mode switching instruction through the communication portion 26 to the digital camera 2 based on the application.

On the other hand, when the control portion 17 of the digital camera 2 receives the remote operation photographing mode switching instruction by the communication portion 15, the control portion 17 switches the mode to the remote operation photographing mode to execute the mode and converts the image data picked up by the image pickup portion 4 of the digital camera 2 into the image data of the through image in the companding portion 17a, as described above. Then, the control portion 17 stores the image data converted into the image data of the through image in HTTP (HyperText Transfer Protocol) packet to transmit the image data to the PC 3 through the communication portion 15.

Then, in the processing in step S2 shown in FIG. 7, the control portion 28 of the PC 3 loads the image data of the through image received by the communication portion 26 to display the loaded image data of the through image to be displayed in a predetermined window size using the activated application.

FIG. 2 shows a display example in this case of the remote operation mode screen displayed by the PC application during the execution of the remote operation photographing mode. As shown in FIG. 2, during the execution of the remote operation mode, the control portion 28 of the PC 3 uses the activated application to display a remote operation screen 24A on which the image data of the through image from the digital camera 2 is displayed in the predetermined window size.

The remote operation screen 24A is an execution screen 30 of the PC application, for example, and includes a through image display area 31 for displaying the through image, a various setting items instruction portion 32 for remotely operating the respective settings of various setting items (for example, scene, size, macro, flash lamp, exposure, image quality, ISO sensitivity, WB (White Balance), photometry, and the like) of the digital camera 2, and a zoom lever portion 33 for remotely operating a zoom optical system provided to the image pickup portion 4 of the digital camera 2 within a range from “tele” to “wide”.

Note that the through image display screen 31 a displayed in the through image display area 31 is shown in FIG. 3.

Then, in the processing in step S3, it is assumed that the user depresses the mouse button at an arbitrary point on the through image display area 31 on the remote operation screen 24A in a state where the remote operation screen 24A shown in FIG. 2 is displayed on the display portion 24 of the PC 3 as described above (the state where the through image display screen 31a is displayed in the through image display area 31: see FIG. 3).

Then, in the subsequent processing in step S4, the control portion 28 of the PC 3 acquires coordinate data (x1, y1) on the through image display area 31 of the point at which the user depressed the mouse button. Note that the acquisition of the coordinate data on the through image display area 31 in this case is performed by a coordinate acquisition portion by detecting an instruction from a control instruction input portion, not shown, provided to the PC 3 by a control signal detection portion.

In this case, for example, the control portion 28 of the PC 3, as shown in the through image display screen 31b in FIG. 3, displays an area 40 corresponding to a part clicked by the mouse and current various setting parameters 41 and acquires the coordinate data corresponding to the area 40.

Then the control portion 28 of the PC 3 transmits the acquired coordinate data to the digital camera 2 through the communication portion 26.

When receiving the coordinate data transmitted from the PC 3 through the communication portion 15 of the digital camera 2, the control portion 17 of the digital camera 2 converts the received and loaded coordinate data into coordinate data (x2, y2) in the image area of an image to be picked up, in the processing in step S5. That is, the control portion 17 of the digital camera 2 detects the focusing position based on the coordinate data transmitted from the PC 3.

In addition, in this case, when acquiring the converted coordinate data, the control portion 17 of the digital camera 2 displays a focusing instruction icon 53 indicating a receipt of the focusing instruction such as shown in FIG. 6, for example, on the display screen 11 A of the display portion 11, in the processing in step S6.

Note that a focusing area is assumed to have similar shape as those of an image pickup area and the through image. However, there is no limitation placed thereon. The focusing area is set in a part of highest contrast, for example, in the designated focusing area (for example, the area 40 clicked by the mouse shown in FIG. 3).

When the contrast is lower than a previously set threshold value, the control portion 17 of the digital camera 2 may transmit information indicating that the digital camera 2 can not focus to the PC 3 through the communication portion 15 by using packets. Needless to say, the image pickup area may be previously divided into blocks to acquire information indicating whether or not focusing is possible in each block, and then information on an area where focusing is possible may be previously transmitted to the PC 3 and display indicating whether or not focusing is possible may be performed on the through image display area 31 of the PC application.

In addition, when the focusing position is detected, the control portion 17 of the digital camera 2 causes settings of photographing parameters (various setting items) to be displayed on the display portion 11 in the processing in step S6.

Thereafter, the control portion 17 of the digital camera 2 performs focusing action in the processing in the subsequent step S7.

When the focusing is completed, the control portion 17 of the digital camera 2 reads out only the focusing area part from the image pickup device of the image pickup portion 4 to convert the size of the part into a size suitable for a through image (for example, QVGA size: 320×240) in the processing in step S8, to cause the companding portion 17a to perform data compressing processing. Note that in the following description of the present embodiment, the through image of only the focusing area part is referred to as an enlarged through image and image data of the enlarged through image as enlarged through image data.

In this case, for example, the relationship between an image pickup area 50 of the image pickup device in the image pickup portion 4 and an enlarged through image area 51 decided based on a designated position 52 by the mouse is as shown in FIG. 5.

In addition, the control portion 17 of the digital camera 2 also generates a through image of the entire image pickup area. Note that in the following description of the present embodiment, the through image of the entire image pickup area is referred to as an entire through image and image data of the entire through image as entire through image data. Furthermore, the step S8 configures an image dividing portion.

Then the control portion 17 of the digital camera 2 transmits photographing setting data and the like, in addition to the generated enlarged through image data and the entire through image data, to the PC 3 through the communication portion 15.

In this case, in a case where the through image data must be transmitted at 15 fps, for example, if both of the enlarged through image data and the entire through image data are transmitted, the communication capacity becomes insufficient in some cases.

Therefore, in the present embodiment, the control portion 17 of the digital camera 2 converts the entire through image data into an image having a size smaller than that before designating the focusing area to transmit the image. Note that in the following description, the reduced entire through image of the entire image pickup area is referred to as a reduced entire through image and the image data of the reduced entire through image as reduced entire through image data.

In addition, in this case, as shown in FIG. 7, both of the enlarged through image data and the reduced through image data can be transmitted by decreasing the frame rate.

Note that, in the present embodiment, such a transmission method of image data from the digital camera 2 to the PC can be set in advance in the remote operation setting, and it is possible to select image quality precedence or follow-up ability precedence, for example.

In addition, if a user would not like to decrease the frame rate as well as to reduce the image quality, it is possible for the control portion 17 of the digital camera 2 to convert from a color image to a grayscale image (256 gradation, for example).

Then, the control portion 17 of the digital camera 2 transmits the generated enlarged through image data and reduced through image data, as one set, to the PC 3 through the communication portion 15, as shown in FIG. 7. The frame rate in this case is previously set.

At that time, photographing setting data is also transmitted to the PC 3. The photographing setting data includes various parameters to be set when focusing is completed (in a case of automatic photographing, exposure, ISO, shutter speed, and the like). If unnecessary, the photographing setting data does not have to be transmitted.

Note that, it is needless to say that each through image transmitted from the digital camera 2 at this time is the one after the photographing settings (the exposure, the ISO sensitivity, and the like) have been reflected to.

After that, in the processing in step S9, the control portion 28 of the PC 3 receives the enlarged through image data and the reduced entire through image data that are transmitted from the digital camera 2 through the communication portion 26, to display the reduced through image on the display portion 24 so as to be superimposed on the enlarged through image and also display the various photographing setting parameters on the same screen in a superimposed manner.

A display example of the display portion 11 of the PC 3 in this case is shown in FIG. 3. That is, in the through image display area 31 on the remote operation screen 24A (see FIG. 2), the through image display screen 31 c is displayed. On the through image display screen 31c, the enlarged through image 40, the reduced through image 42 superimposed thereon, and the various setting parameters 41 are displayed.

Then the procedure moves on to the processings in step S11 and step S12 through the processing in step S10. In the processing in step S11, in a case where the focusing position is not at a desired position, if the user performs drag action in left/right or up/down direction or wheel rotation action while depressing the mouse button on the through image display screen 31c on the remote operation screen 24A, the control portion 28 of the PC 3 transmits, by the processing in step S12, fine adjustment data according to the drag amount or wheel rotation amount to the digital camera 2 through the communication portion 26.

When receiving the fine adjustment data, the control portion 17 of the digital camera 2 controls an AF motor (not shown) in the image pickup portion 4 to fine-adjust the focusing position in the processing in step S13. At this time, the control portion 17 of the digital camera 2 generates a through image of a fine-adjusted focusing area in the processing in step S14 to transmit the generated through image to the PC 3 through the communication portion 15.

According to this, the control portion 28 of the PC 3 causes the respective through image data and the photographing setting data to be displayed on the display portion 11 in the processing in step S15 similarly as that in the step S9, and thereby the fine-adjusted respective through images are displayed again on the through image display screen 31c displayed on the display portion 11. Therefore, the user can acquire an accurately focused image.

Note that the step S9 and the step S15 configure the image display portion. That is, the image display portion is configured of the control portion 28 of the PC 3 and the like.

Then, in a case where the focusing position is at a desired position, when the user releases the mouse button in a procedure in step S16, the control portion 28 of the PC 3 detects a falling edge (low level at the time t2 in FIG. 4) of the mouse button signal as shown in FIG. 4, and generates a release command to be transmitted from the PC 3 to the digital camera 2, to transmit the release command to the digital camera 2 through the communication portion 26 in the processing in step S17.

Note that, as shown in FIG. 4, when the user depresses the mouse button, the mouse button signal rises at the time t1, for example, and when releases, the mouse button signal falls as described above.

Thereafter, when receiving the release command in the processing in step S18, the control portion 17 of the digital camera 2 performs release action in the processing in step S18, and performs image processing simultaneously with photographing in the processing in step S19, and then performs compression processing on the image data of the photographed image through the companding portion 17a in the processing in step S20.

Then, the control portion 17 of the digital camera 2 controls such that compressed image data of the picked-up image is stored in the storage portion 9 in the step S21 and transmits the compressed image data to the PC 3 through communication portion 15.

After that, the control portion 28 of the PC 3 controls such that the photographed image based on the transmitted compressed image data after photographing is displayed on the through image display area 31 on the remote operation screen 24A in the processing in step S22, and thereafter the compressed image data of the picked-up image is stored in the storage portion 22 similarly as the digital camera 2, to terminate the remote operation mode including photographing.

Note that FIG. 3 shows an example of photographed image displayed on the display portion 24 (in the through image display area 31 on the remote operation screen 24A) of the PC 3 in the processing in step S22. In this case, on the through image display screen 42a, in addition to the photographed image, various setting parameters 41 a at the time of photographing are displayed in a superimposed manner.

In addition, in a case of canceling the focusing position, when the user depresses the right button of the mouse, the control portion 28 of the PC 3 performs control to release the focusing mode and to restore the through image display state. Needless to say, there is no problem even if the focusing mode is released by the control portion 28 when the user removes the mouse pointer from the through image display screen on which the through image is displayed, or the focusing mode may be released by other operations.

Note that, in the present embodiment, when the enlarged through image part of the through image which is instructed by the mouse operation is an area where focusing is impossible, it may be controlled such that a notice indicating that the area is focusing impossible area is displayed on the remote operation screen 24A of the PC 3 and the display portion 11 of the digital camera 2 to warn the user to take precautions. That is, the control portions 28, 17 of the PC 3 and the digital camera 2 configure the warning portions, respectively.

Therefore, with the present embodiment, it is possible to realize the remote photographing system 1 capable of bringing the digital camera 2 into accurate focus by other devices side, that is, the PC 3, at the time of remotely operating the digital camera 2, without checking the image after photographing.

Note that the present invention is not limited to the above-described embodiments and various modifications can be made without departing from the scope of the invention.

What is claimed is:

1. A remote photographing system comprising a photographing device, and a remote operation device for remotely operating the photographing device by a wireless or a wired communication method, wherein the photographing device includes:
a data receiving portion for receiving various data transmitted from the remote operation device;
a focal point adjusting portion for adjusting a focus when acquiring an image of a subject;
an image acquisition portion for acquiring the image of the subject; and
a transmitting portion for transmitting the image to the remote operation device, and
the remote operation device includes:
an image receiving portion for receiving the image transmitted from the photographing device;
an image display portion for displaying the image transmitted from the photographing device;
an instruction portion for instructing an arbitrary part of the image displayed on the image display portion;
an enlarged display portion for displaying the arbitrary part of the image instructed by the instruction portion in an enlarged manner;
a positional information acquisition portion for acquiring positional information of the arbitrary part of the image instructed by the instruction portion; and
a transmitting portion for transmitting the positional information to the photographing device, and
the focal point adjusting portion adjusts to bring the arbitrary part of the image instructed by the instruction portion into focus.

2. The remote photographing system according to claim 1, wherein the instruction portion instructs the arbitrary part of the image displayed on the image display portion by using a pointing device.

3. The remote photographing system according to claim 2, wherein the remote operation device further includes a fine adjusting portion for instructing to fine adjust to a result of focal point adjustment by the focal point adjusting portion.

4. The remote photographing system according to claim 3, wherein the pointing device is a mouse and the fine adjusting portion adjusts a focus by a rotation action of the wheel of the mouse or a drag action of the mouse.

5. The remote photographing system according to claim 1, further comprising:
a dividing portion for dividing the image acquired by the image acquisition portion into a plurality of areas; and
a determining portion for determining whether or not focusing is possible for each of the areas,
wherein the image display portion displays a determination result by the determination portion on the image displayed on the image display portion in a superimposed manner.

6. The remote photographing system according to claim 5, further comprising a warning portion for issuing a warning in a case where an image part instructed by the instruction portion is an area where focusing is not possible.
